(19) United States
(12) Patent Application Publication
(10) Pub. No.: US 2025/0305335 A1
(43) Pub. Date: Oct. 2, 2025

(54) Shower Door Hinge Having a Concealed Low-Friction Knuckle

(71) Applicant: Randy Tasman, Huntington Station, NY (US)

(72) Inventor: Randy Tasman, Huntington Station, NY (US)

(21) Appl. No.: 18/617,562

(22) Filed: Mar. 26, 2024

(51) Int. Cl. E05F 1/12

(52) U.S. Cl. CPC E05D 5/0246; E05D 11/1064; E05F 1/1253; E05Y 2201/628; E05Y 2201/638; E05Y 2600/41; E05Y 2900/114

(57) ABSTRACT

A shower door hinge is being presented. It consists of three main components: a door clamping member, a wall mounting plate, and a concealed knuckle device with at least one low-friction element. The door clamping member is responsible for engaging the shower door, while the wall mounting plate is mounted on the side wall of the shower stall. The low-friction knuckle device, which is hidden from view within the door clamping member, is made up of several parts. It includes a hinge and a hinge pin that serve as the axis of rotation for the shower door. Additionally, there is a spring-biased pin that works in conjunction with the hinge, enabling a camming action.

### FIELD OF THE INVENTION

The present invention relates to a decorative shower door hinge, and more particularly, to a wall mounted decorative outwardly swinging shower door hinge having a concealed low-friction knuckle.

### BACKGROUND INFORMATION

Bathroom design and attention to detail in interior design has become important to homeowners with an emphasis on both aesthetics and functionality.

There have been various patents regarding shower doors that achieved a functional purpose but did so at the expense of outward design elements, whereby the mechanisms were bulky, exposed ugly mechanical mechanisms or some combination thereof. Such patents prior art such as U.S. Pat. Nos. 5,367,745, and 5,588,181, and 5,448,799 demonstrated the need for more attention made to aesthetics while still achieving the primary purpose of a shower door hinge.

U.S. Pat. No. 5,867,871 responded to the need for a more aesthetic shower door hinge with a hidden knuckle. This prior art reference lacked a way for controlling the mechanism and the way in which the shower door closed. Many homeowners may want a certain swing, stop points, or speed of closure based upon their preferences. Whereas, U.S. Pat. No. 9,422,757 provided various ways for controllable rotation of a glass door, which show the importance of this feature but did not provide any ways that were aesthetically pleasing, whereby the mechanism was an exposed yet controlled swing.

Thus, there is a need for a decorative shower door hinge in which the knuckle of the hinge is not exposed, however, in such a concealed knuckle design there must also be a needed for a simultaneously improved mechanical design, whereby the knuckle can further include a novel low-friction design through various means. So far a shower door hinge has not achieved the combination of improved mechanical design, and functionalizing the closing mechanism in its actuation for the preference of the homeowner, in combination with an aesthetically pleasing nature by its very design.

### SUMMARY OF THE INVENTION

Accordingly, it is an object of the present invention is a wall-mounted outwardly-swinging shower door hinge assembly with a concealed low-friction knuckle, comprising: a door clamping member for grasping the shower door on a front and rear side thereof, the clamping member having a front decorative plate adapted to cooperatively engage the front side of the shower door and a cooperative rear plate engageable with the rear side of the shower door, the front decorative plate further having a substantially uninterrupted decorative outer surface; a hinge pin having a first rotational axis, housed within and supported between said front and rear plates; and a wall mounting plate having at least one aperture for receiving at least one wall engaging fastener therethrough and a forwardly extending hinge adapted to receive said hinge pin therethrough, the hinge having a substantially circular outer surface with a flat on one side thereof and being sized to fit within the front and rear plates of the door clamping member; at least one low-friction element that rotates about the first rotational axis, wherein said hinge pin in conjunction with at least the first low-friction element acts to cooperatively hold the door clamping member in swinging engagement with the wall mounting plate and is the focal point for an axis of rotation between the two.

Another object of the present invention is to provide a decorative wall mounted shower door hinge which satisfies the aesthetic taste of today's family while also being of a rugged design capable of withstanding continuous and repetitive use.

Another object of the present invention is to enable construction of a wall mounted shower door hinge in which the knuckle or joint of the hinge is concealed from view without reducing an adequate range of motion for the opening and closing of the shower stall door.

It is a further objective of the present invention to allow for construction of an outwardly swinging shower door hinge having a concealed knuckle which is both practical and has a reasonable cost to manufacture.

Yet another object of the present invention is to construct a shower door hinge having a hidden knuckle which is mountable either on a wall or another piece of glass.

To achieve the foregoing and further objectives, and in accordance with the purposes of the present invention, as embodied and broadly described herein, the present invention is directed to a decorative outwardly swinging shower door hinge having a hidden knuckle.

The shower door hinge is constructed, according to an embodiment of the present invention, to have a door clamping member, a wall mounting plate and a knuckle device. The door clamping member engages the shower door while the wall mounting plate is mounted on a side wall of the shower stall. The knuckle device acts as the point of rotation for the shower door hinge.

The door clamping member itself has a decorative front plate which engages a front side of the shower door and a rear plate which engages a rear side of the shower door. A gasket, made of rubber or other similar material, is placed between each of the two plates of the door clamping member and the respective sides of the shower door. The wall mounting plate itself is mounted to the wall and holds the structure of the shower door hinge, and correspondingly the shower door, in place.

The knuckle device, which is comprised of several parts, is enclosed within the door clamping member, thereby hidden from view. The knuckle device has, as a first and second part, a hinge and a hinge pin which form the axis of rotation about which the shower door rotates. The knuckle device also has, as another part, a spring biased pin which cooperatively acts with the hinge. The cooperative action between the hinge and the spring biased pin allow for a camming action which controls both the rate of rotation and the positioning of the shower door around the axis of rotation.

The present invention and its features and advantages will become more apparent from the following detailed description with reference to the accompanying drawings.

### BRIEF DESCRIPTION OF THE DRAWINGS

FIG. 1 shows a view of a shower door mounted by an embodiment of the present invention to the wall of a shower stall.

FIG. 2 shows a right side view of the shower door hinge where the shower door clamping member is directed towards the viewer, according to an embodiment of the present invention.

FIG. 3 shows a left side view of the shower door hinge where the shower door clamping member is directed away from the viewer, according to an embodiment of the present invention.

FIG. 4 shows a right side view of the shower door hinge where the wall mounting plate is directed towards the viewer, according to an embodiment of the present invention.

FIG. 5a shows a top cut-away view of the shower door hinge in a first position, cut-away along axis 5-5 of FIG. 4, according to an embodiment of the present invention, where the frictional element is one possible embodiment of a sleeve bushing.

FIG. 5b shows a top cut-away view of the shower door hinge in a first position, cut-away along axis 5-5 of FIG. 4, according to an embodiment of the present invention, where the frictional element is one possible embodiment of a sleeve bushing with a discrete functionalized surface.

FIG. 5c shows a top cut-away view of the shower door hinge in a first position, cut-away along axis 5-5 of FIG. 4, according to an embodiment of the present invention, where the frictional element is one possible embodiment of a sleeve bushing with a cam-style functionalized surface.

FIG. 5d shows a top cut-away view of the shower door hinge in a first position, cut-away along axis 5-5 of FIG. 4, according to an embodiment of the present invention, where the frictional elements are one possible embodiment of a cam-style functionalized bushing and a mating functionalized member.

FIG. 6a shows a top cut-away view of the shower door hinge in a second position, cut-away along axis 5-5 of FIG. 4, according to an embodiment of the present invention, where the frictional element is one possible embodiment of a sleeve bushing.

FIG. 6b shows a top cut-away view of the shower door hinge in a second position, cut-away along axis 5-5 of FIG. 4, according to an embodiment of the present invention, where the frictional element is one possible embodiment of a sleeve bushing with a discrete functionalized surface.

FIG. 6c shows a top cut-away view of the shower door hinge in a second position, cut-away along axis 5-5 of FIG. 4, according to an embodiment of the present invention, where the frictional element is one possible embodiment of a sleeve bushing with a cam-style functionalized surface.

FIG. 6d shows a top cut-away view of the shower door hinge in a second position, cut-away along axis 5-5 of FIG. 4, according to an embodiment of the present invention, where the frictional elements are one possible embodiment of a cam-style functionalized bushing and a mating functionalized member.

FIG. 7 shows a side cut-away view of the shower door clamping member of the shower door hinge, cut-away along axis 7-7 of FIG. 2, according to another embodiment of the present invention.

### DETAILED DESCRIPTION

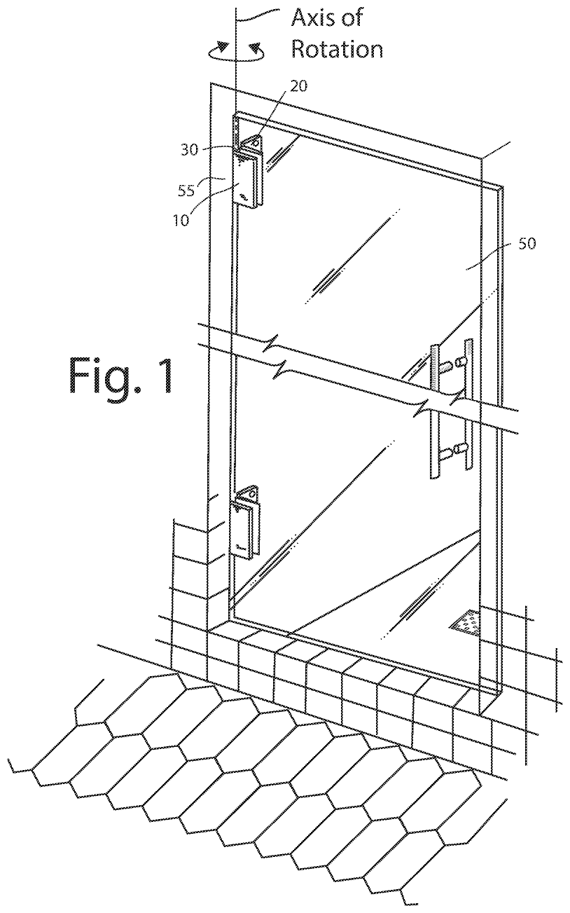

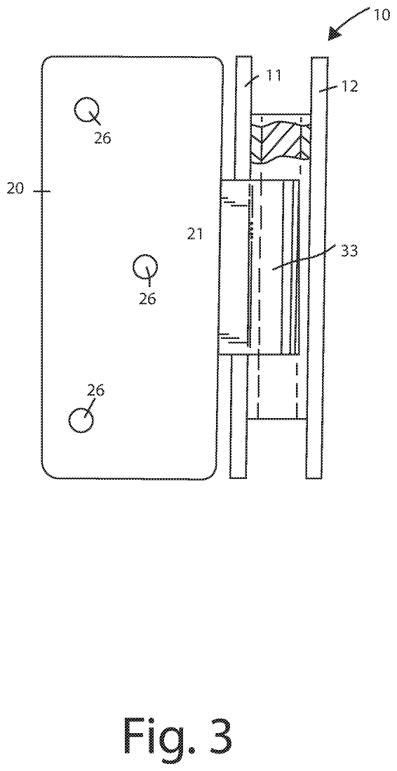

FIGS. 1 to 7 depict a shower door hinge that features a concealed knuckle and at least one low-friction element, according to the embodiment of the present invention. In FIG. 1, you can see the components of the hinge: a door clamping member (10), a wall mounting plate (20), and a concealed knuckle device (30). The door clamping member (10) is connected to the shower door (50), while the mounting plate (20) is attached to the shower stall wall (55). The knuckle device (30) acts as the axis of rotation for the shower door (50). The preferred embodiment in FIG. 1 shows two wall-mounted shower door hinges, but it is possible to use more than one hinge in the shower stall for the shower door's operation.

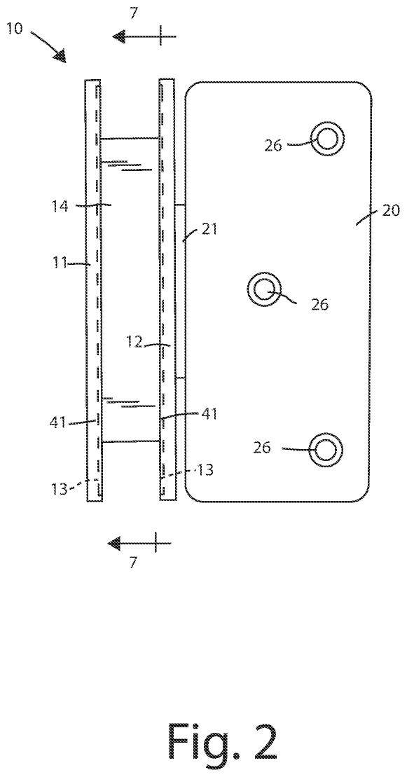

Referring to the provided figures (FIGS. 2, 3, and 4), the door clamping member (10) consists of two main components. Firstly, there is a decorative front plate (11) that engages the front surface of the shower door 50. Secondly, there is a rear plate 12 that engages the rear surface of the shower door (50). To ensure a secure fit, rubber gaskets (13) are placed in the recesses (41) on both the front plate (11) and the rear plate (12). These gaskets serve two important purposes. Firstly, they prevent scratching of the shower door surfaces. Secondly, they prevent water leakage between the shower door and the shower door hinge. It is worth noting that the recesses are slightly deeper than the gaskets to avoid exposing them.

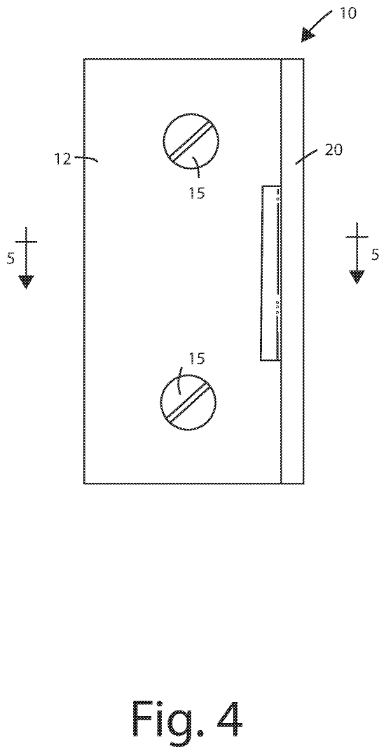

The decorative front plate (11) and the rear plate (12) of the door clamping member 10 are connected and held together by a beveled plate retainer screw (15). The plate retainer screw (15) is screwed through a countersink screw hole (not shown) cut in the rear plate (12) and into a countersink screw thread bore 16 in a knuckle compartment (14). The knuckle compartment (14) is integrally attached to the decorative front plate 11. Thus the rear plate (12) is removable from the front plate (11) and knuckle compartment (14) by unscrewing the plate retainer screw (15). This removability of the rear plate (12) allows for shower door (50) removal and/or repair of the concealed knuckle device (30). A preferred embodiment of the present invention calls for two plate retainer screws (15), as shown in FIG. 4. It is, of course, to be understood that one or more than one retainer screws (15) may be used to secure the two plates of the door clamping member (10) together.

Referring to FIGS. 2, 3, and 4, the wall mounting plate (20) can be attached to the shower stall wall (55) using a screw (not shown). The screw should be suitable to securely fasten the entire assembly of the shower door hinge and shower door to the wall, considering their combined weight. In the preferred embodiment, as shown, the wall mounting plate (20) has three countersink holes (26) for three screws. However, it is possible to use one or more screws or any other wall fastening devices/methods that can securely attach the wall mounting plate (20) to the shower stall wall (55). Additionally, the wall mounting plate (20) is designed with an integrally connected neck (21) that extends laterally from its body. This allows the concealed knuckle device (30) to freely rotate about the axis of rotation.

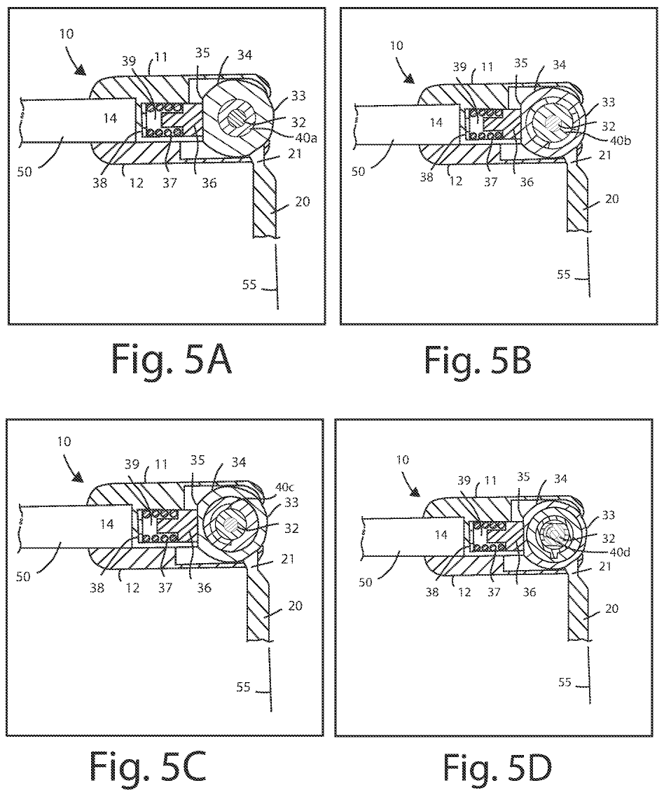

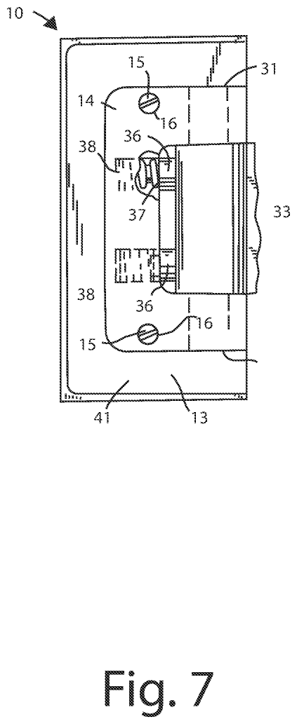

Referring to FIGS. 5A-D, 6A-D, and 7, the knuckle compartment (14), which is integrally attached to the decorative front plate (11), serves the purpose of concealing the knuckle device (30) from view. The knuckle compartment (14) may feature a vertical throughbore (31) as in FIG. 7 that is centered on the axis of rotation, around which the shower door (50) rotates. Inside the vertical throughbore (31), there is a hinge pin (32) that extends the entire vertical length of the knuckle compartment (14). Additionally, the vertical throughbore (31) has a hollow area where a hinge (33) is inserted and contained. The hinge (33) also has an axial throughbore for the hinge pin (35). The hinge pin (35) keeps the hinge (33) in place and acts as the axis of rotation.

The hinge (33) is connected to the neck (21) of the wall mounting plate (20). It has a circular outer surface (34) with a flat cam surface (35) on one side. This allows for a camming effect when the door clamping member (10) and shower door (50) are rotated, as shown in FIGS. 5A-D and 6A-D. Additionally, the hinge friction can be improved by utilizing an at least one sleeve bearing (40) or equivalent low-friction member. The camming effect can also be customized by functionalizing the low-friction element and its frictional surface (40b, 40c, 40d) as shown in FIG. 5B-D. Any combination of camming or rotational set points can be achieved by functionalizing the low-friction element's surface.

The hinge (33) is acted against by a biasing pin (36), which is biased by a biasing spring (37). Both the biasing pin (36) and biasing spring (37) are contained within a hollow bore (39) in the knuckle compartment (14). To secure the biasing spring (37) in place, a washer (38) can be placed at the end of the hollow bore (39). The biasing pin (36) is shaped to guide the biasing spring (37). It's important to note that in the preferred embodiment shown in FIG. 7, two biasing pins (36) are used.

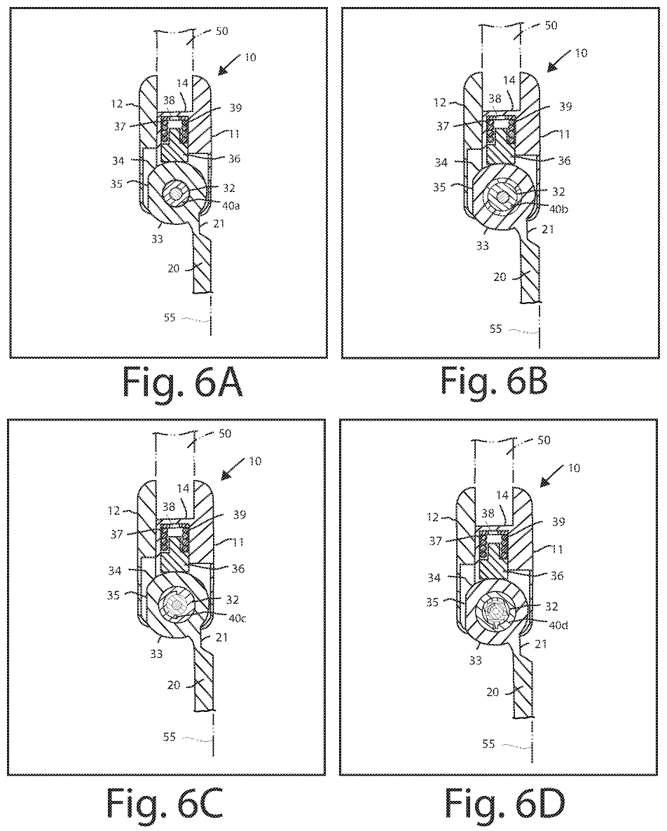

The knuckle device (30) in the shower door mechanism utilizes the camming action created by the biasing force of the biasing spring (37). This force acts against the biasing pin (36), which in turn presses against the circular outer surface (34) and the flat cam surface (35) of the hinge (33). When the shower door (50) is closed, as shown in FIG. 5, the biasing spring (37) is fully extended and the biasing pin 36 is flush against the flat cam surface 35. However, when the shower door (50) is moved to the open position, as shown in FIG. 6, the biasing pin (36) rides over the edge between the flat cam surface 35 and the circular outer surface (34) of the hinge (33). This movement causes the biasing spring (37) to contract, increasing the biasing force against the biasing pin (36). As a result, the camming action allows for controlled movement of the shower door (50) and effectively “locks” it in either the open or closed position.

It is to be understood and expected that variations in the principles of construction herein disclosed may be made by one skilled in the art and it is intended that such modifications, changes, and substitutions are to be included within the scope of the present invention.

What is claimed is:

1. A wall-mounted outwardly-swinging shower door hinge assembly with a concealed low-friction knuckle, comprising:
a door clamping member for grasping the shower door on a front and rear side thereof, the clamping member having a front decorative plate adapted to cooperatively engage the front side of the shower door and a cooperative rear plate engageable with the rear side of the shower door, the front decorative plate further having a substantially uninterrupted decorative outer surface;
a hinge pin having a first rotational axis, housed within and supported between said front and rear plates; and
a wall mounting plate having at least one aperture for receiving at least one wall engaging fastener therethrough and a forwardly extending hinge adapted to receive said hinge pin therethrough, the hinge having a substantially circular outer surface with a flat on one side thereof and being sized to fit within the front and rear plates of the door clamping member;
at least one low-friction element that rotates about the first rotational axis,
wherein said hinge pin in conjunction with at least the first low-friction element acts to cooperatively hold the door clamping member in swinging engagement with the wall mounting plate and is the focal point for an axis of rotation between the two.

2. The wall-mounted outwardly-swinging shower door hinge assembly with a concealed low-friction knuckle in accordance with claim 1, wherein the low-frictional element is a single sleeve bushing with a non-functionalized surface.

3. The wall-mounted outwardly-swinging shower door hinge assembly with a concealed low-friction knuckle in accordance with claim 1, wherein the low-frictional element is a sleeve bushing with a cam-functionalized surface.

4. The wall-mounted outwardly-swinging shower door hinge assembly with a concealed low-friction knuckle in accordance with claim 1, wherein the low-frictional elements are a bushing with a cam-functionalized surface and a mating functionalized member.

5. The wall-mounted outwardly-swinging shower door hinge assembly with a concealed low-friction knuckle in accordance with claim 1, which further includes a spring member disposed in apertures disposed within the door clamping member and which are biased into and engageable with the outer surface of the hinge.

6. The wall-mounted outwardly-swinging shower door hinge assembly with a concealed low-friction knuckle in accordance with claim 5, wherein said spring member and the hinge create a cam effect that controls the rotation and position of the shower door.

7. The wall-mounted outwardly-swinging shower door hinge assembly with a concealed low-friction knuckle in accordance with claim 6, wherein said spring member and the hinge in combination of the low-friction element about at least the first rotational axis, create a camming effect by which a speed of rotation of the shower door can be controlled as well as a positioning of the shower door.

8. The wall-mounted outwardly-swinging shower door hinge assembly with a concealed low-friction knuckle in accordance with claim 1, wherein each of the front and rear plates of the door clamping member have recesses on the shower door engaging sides thereof, and a gasket member respectively disposed therein for engagement with the shower door, the recess being of a depth slightly greater than the thickness of the gasket member to avoid any exposure of the gasket member.

9. A wall-mounted outwardly-swinging shower door hinge assembly with a concealed low-friction knuckle, comprising:
a door clamping member having a front plate and rear plate, for respectively engaging a front side and a rear side of the shower door, and further having a hollow compartment housed between and attached to one of said front and rear plates, said hollow compartment having a first axial throughbore extending therethrough;
a wall mounting plate, for mounting the shower door hinge assembly on a wall of a shower stall, having a hinge extending from a neck on the wall mounting plate and sized to fit into the hollow compartment, the hinge having a substantially circular outer surface, a flat cam surface on one side and a second axial throughbore;
a knuckle device having a hinge pin adapted to fit in said first axial throughbore of said hollow compartment and at least one biasing pin disposed within said hollow compartment, both for engagement with the hinge;
at least one low-friction element that rotates about the first rotational axis,
wherein said hinge pin in conjunction with at least the first low-friction element acts to cooperatively hold the door clamping member in swinging engagement with the wall mounting plate and is the focal point for an axis of rotation between the two.

10. The wall-mounted outwardly-swinging shower door hinge assembly with a concealed low-friction knuckle in accordance with claim 9, wherein the at least one biasing pin is biased against the hinge by at least one biasing spring.

11. The wall-mounted outwardly-swinging shower door hinge assembly with a concealed low-friction knuckle in accordance with claim 9, wherein the biasment of the at least one biasing spring and at least one biasing pin against the hinge creates a camming effect in which a rate of rotation and a position of the shower door around the axis of rotation can be controlled.

12. The wall-mounted outwardly-swinging shower door hinge assembly with a concealed low-friction knuckle in accordance with claim 9, wherein a gasket is placed between each of the front and rear plates of the door clamping member and the respective front and rear sides of the shower door.
